(19) United States
(12) Patent Application Publication
(10) Pub. No.: US 2007/0019376 A1
(43) Pub. Date: Jan. 25, 2007

(54) DRIVE BRACKET STRUCTURE

(75) Inventor: Guang-Yi Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,814

(22) Filed: May 11, 2006

(30) Foreign Application Priority Data
Jul. 22, 2005 (CN) 200520061961.X

(51) Int. Cl. G06F 1/16

(52) U.S. Cl. 361/685

(57) ABSTRACT

A bracket structure includes a first bracket, a second bracket, and a locking member. The first bracket includes a first plate. A first slideway and a second slideway are defined in the first plate. The second bracket includes a pair of sliding members for being slidably received in the first and second slideways respectively. The locking member is slidably mounted to the first plate of the first bracket. The locking member includes a body for engaging with the sliding members when the second bracket is mounted to the first bracket, and a pair of protrusions each defining an avoiding slot therebelow for allowing the corresponding sliding members to pass therethrough when assembling or disassembling the second bracket to or from the first bracket.

### CROSS-REFERENCE TO RELATED APPLICATIONS

This application is related to U.S. patent application Ser. No. 10/308634 (now U.S. Pat. No. 6,801,427) entitled “DRIVE BRACKET STRUCTURE”, assigned to the same assignee with this application.

### FIELD OF THE INVENTION

The present invention relates to drive bracket structure for use in equipment such as a computer enclosure, and in particular to a drive bracket structure which has a drive bracket readily attached to another drive bracket.

### DESCRIPTION OF RELATED ART

A personal computer enclosure usually includes first and second drive brackets for accommodating data storage devices therein. Typically, the first drive bracket is firstly secured to the computer enclosure, and the second drive bracket is subsequently fastened to a bottom of the first drive bracket. The second drive bracket is usually secured directly to the first drive bracket with screws.

Taiwan Patent Application No. 83202773 discloses a fastening means by which the second drive bracket is directly fastened to the pre-installed first drive bracket using screws. Screw holes are defined in the first drive bracket. Flanges are formed at upper portions of the second drive bracket. At least two through-holes are defined in each flange. Screws fasten the second drive bracket to the first drive bracket. However, installation and removal of the second drive bracket is unduly complicated and laborious. Furthermore, when the screws are secured in the through-holes and the screw holes with a tool during assembly, components of the computer are prone to be accidentally damaged.

Taiwan Patent Application No. 81205427 discloses a fastening means by which the second drive bracket is slidably fastened to the first drive bracket. The first drive bracket forms flanges at opposite sides thereof. The second drive bracket forms tabs corresponding to the flanges of the first drive bracket. In assembly, the second drive bracket is engaged with the pre-installed first drive bracket from a rear of the first drive bracket. The tabs of the second drive bracket are slid straight along the corresponding flanges of the first drive bracket until the second drive bracket is fully engaged under the first drive bracket.

To perform such installation, significant space within the enclosure rearward of the first drive bracket is required. Such space effectively adds to the size of the enclosure, making the enclosure less compact and less convenient.

What is desired, therefore, is a drive bracket structure which overcomes the above-mentioned problems.

### SUMMARY OF THE INVENTION

An exemplary bracket structure includes a first bracket, a second bracket, and a locking member. The first bracket includes a first plate. A first slideway and a second slideway are defined in the first plate. The second bracket includes a pair of sliding members for being slidably received in the first and second slideways respectively. The locking member is slidably mounted to the first plate of the first bracket. The locking member includes a body for engaging with the sliding members when the second bracket is mounted to the first bracket, and a pair of protrusions each defining an avoiding slot therebelow for allowing the corresponding sliding members to pass therethrough when assembling or disassembling the second bracket to or from the first bracket.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a drive bracket structure in accordance with a preferred embodiment of the present invention, together with a chassis partially cut away, the drive bracket structure includes a first bracket, a second bracket, a locking member, and a mounting plate;

FIG. 2 is an isometric view of the locking member of FIG. 1, but an inverted view;

FIG. 3 is a partly assembled view of FIG. 1;

FIG. 4 is similar to FIG. 1, showing the second bracket suspending under the first bracket;

FIG. 5 is an assembled view of FIG. 1, showing the second bracket unlocked; and

FIG. 6 is similar to FIG. 5, showing the second bracket locked.

### DETAILED DESCRIPTION OF THE INVENTION

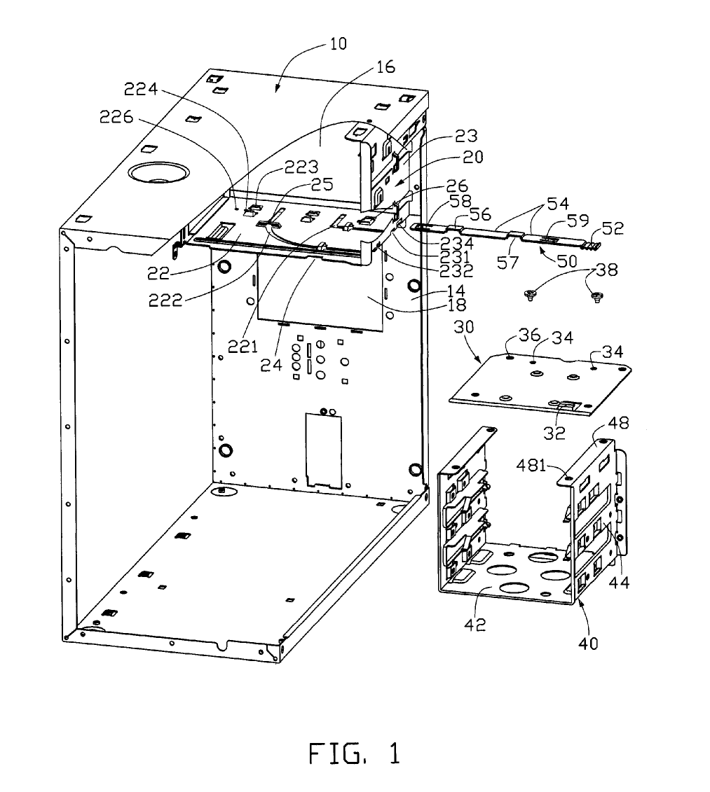

Referring to FIG. 1, a drive bracket structure in accordance with a preferred embodiment of the present invention includes a first bracket 20 for holding data storage devices therein, a second bracket 40 for holding data storage devices therein, a mounting plate 30, and a locking member 50. All these components are mountable within a chassis 10 of a computer enclosure.

The chassis 10 includes a front panel 14. The front panel 14 defines a first opening 16 in a top portion thereof, and a second opening 18 below the first opening 16.

The first bracket 20 is secured to the front panel 14 at the first opening 16. The first bracket 20 includes a first bottom plate 22, and a pair of first side plates 23 extending up from opposite sides of the first bottom plate 22. A first slideway 221 includes two straight portions oriented at an angle to each other. In the preferred embodiment, the angle is a right angle. The second slideway 222 includes two straight portions parallel to the two portions of the first slideway 221 respectively, and an arcuate connecting portion interconnecting said two straight portions. A plurality of reinforcing ribs 25 is formed on the first bottom plate 22 across the first and second slideways 221, 222. A plurality of pairs of aligned catches 223 is stamped up from the first bottom plate 22. Each catch 223 has an L-shaped profile. An opening 26 is defined in the first bottom plate 22 between one pair of catches 223. A cutout 24 is defined in a rear edge of the first bottom plate 22. A lower portion of one of the first side plates 23 defines a slot 234 in alignment with the pairs of catches 223, a first entry 231 communicating with the first slideway 221, and a second entry 232 communicating with the second slideway 222. The first bottom plate 22 defines a first locking hole 224 in alignment with the pairs of catches 223 at one end thereof opposite to the slot 234, and a second locking hole 226 in alignment with the catches 223 between the first locking hole 224 and the other side plate 23.

The second bracket 40 includes a second bottom plate 42, and a pair of second side plates 44 extending up from opposite sides of the bottom plate 42. A flange 48 perpendicularly extends in from an upper portion of each of the pair of second side plates 44. A pair of mounting holes 481 is defined in each flange 48.

The mounting plate 30 is generally rectangular. A pair of screw holes 34 is defined in a front side of the mounting plate 30. Two sliding members 38, such as screws, correspond to the screw holes 34, respectively. A mounting hole 36 is defined in each of four corners of the mounting plate 30. An L-shaped locating tab 32 is stamped up from a rear side of the mounting plate 30 opposite to the screw holes 34.

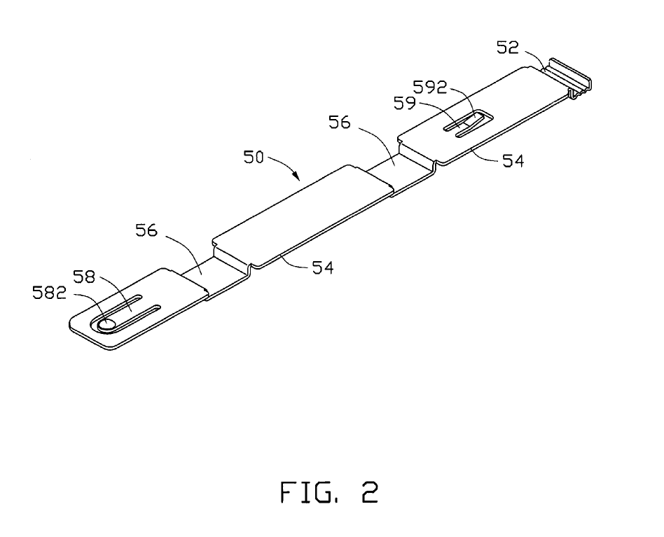

Referring also to FIG. 2, the locking member 50 includes a body 54, an operating portion 52 at one end of the body 54. Two spaced bridge-shaped protrusions 56 each defining an avoiding slot 57 therebelow are stamped up from the body 54. A resilient tab 58 is stamped from one end of the body 54 opposite to the operating portion 52. A locating portion 582 protrudes down from a distal end of the resilient tab 58. A resilient finger 59 is stamped from the body 54 adjacent the operating portion 52. A slanting portion 592 slantingly extends down from a distal end of the resilient finger 59.

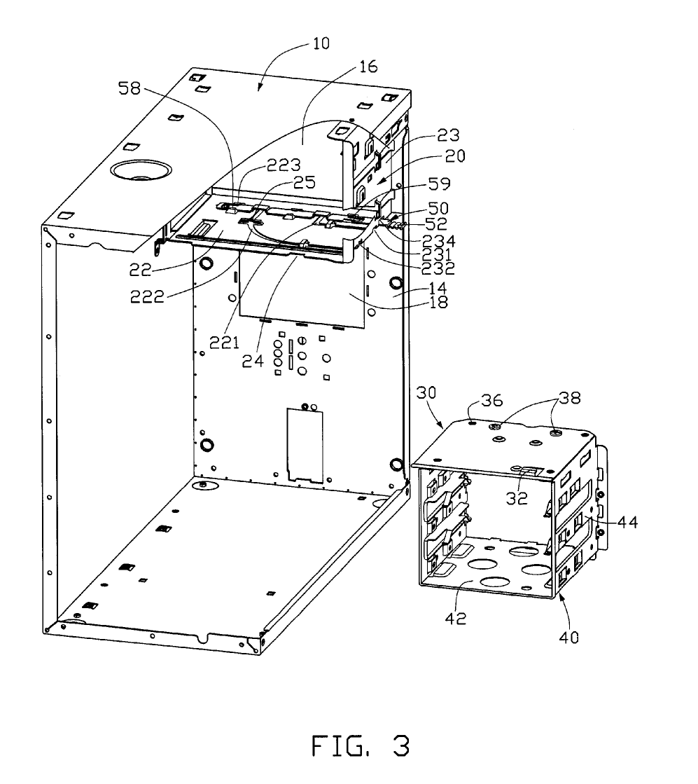

Referring also to FIG. 3, in pre-assembly, the mounting plate 30 is placed on the second bracket 40. The mounting holes 36 of the mounting plate 30 are aligned with the corresponding mounting holes 481 of the second bracket 40. Rivets are extended through the mounting holes 36 and 481 to secure the mounting plate 30 to the second drive bracket 40. The sliding members 38 are respectively engaged in the corresponding screw holes 34. The locking member 50 is inserted through the slot 234 to be accommodated between every pair of catches 223.

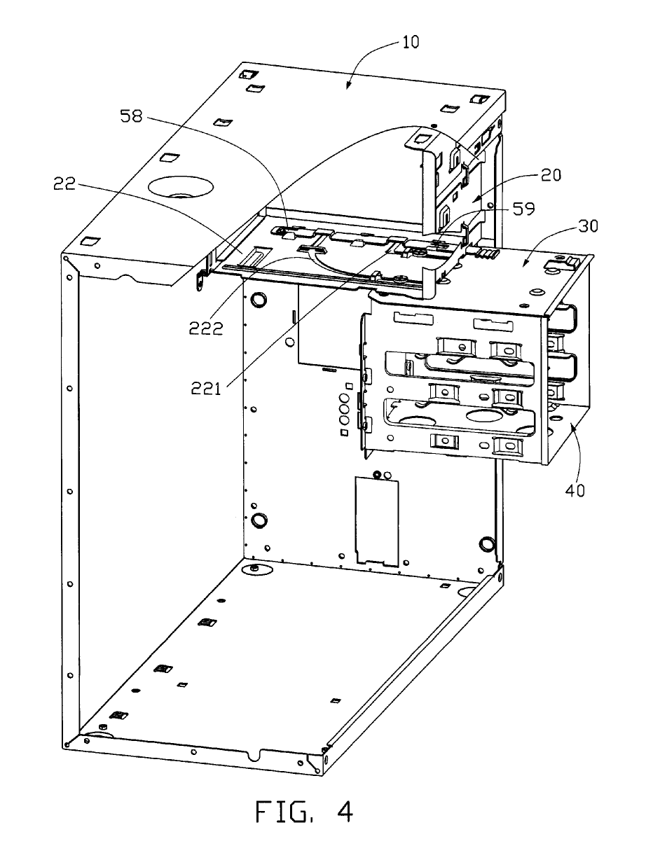

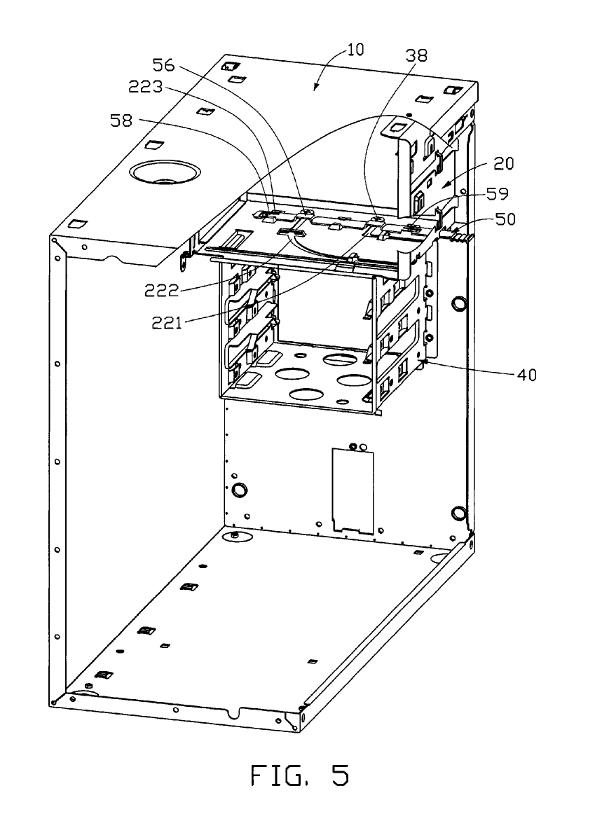

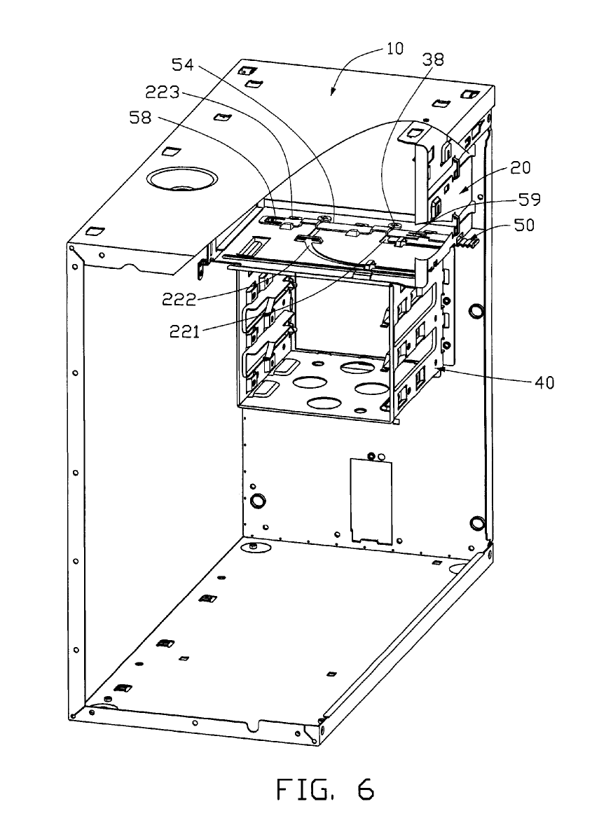

Referring also to FIGS. 4-6, in assembling the second bracket 40 to the first bracket 20, the locking portion 582 of the locking member 50 is engaged in the first locking hole 224, with the protrusions 56 riding above the corresponding first and second slideways 221, 222. The combined assembly mounting plate 30 and second bracket 40 is inserted into the chassis 10 from a side thereof. The sliding members 38 of the mounting plate 30 are slidably received in the corresponding first and second slideways 221, 222 through the first and second entries 231, 232 respectively. The sliding members 38 slide straightly along outmost straight portions of the first and second slideways 221, 222, till the sliding member 38 in the first slideway 221 reaches a junction of the two straight portions of the first slideway 221. The sliding member 38 in the first slideway 221 rotates about the junction of the two straight portions of the first slideway 221. The sliding member 38 in the second slideway 222 slides along the arcuate portion of the second slideway 222, till the second side plates 44 of the second bracket 40 are parallel to the first side plates 23 of the first bracket 20. The sliding members 38 slide straightly along straight portions parallel to the first side plates 23 of the first and second slideways 221, 222. The sliding members 38 slide through the avoiding slots 57 below the protrusions 56 of the locking member 50. The locating tab 32 moves to the cutout 24 of the first bottom plate 22 of the first bracket 20, with the edge of the first bottom plate 22 in the cutout 24 is sandwiched between the locating tab 32 and the mounting plate 30. The locking member 50 is moved to engage the locking portion 582 thereof in the second locating hole 226 of the first bottom plate 22. The resilient finger 592 of the locking member 50 is engaged in the opening 26 of the first bracket 20. The body 54 of the locking member 50 blocks the sliding members 38. Thus, the second bracket 40 is secured at the second opening 18 of the front panel 14.

In disassembly, the locking member 50 is disengaged from the second locating hole 226 and moved to engage in the first locating hole 224. Thus, the second bracket 40 can be removed from the chassis 10.

In a second embodiment of the present invention, the two straight portions of the first slideway 221 may be interconnected by an intermediate arcuate portion.

In a third embodiment of the present invention, the flanges 48 of second bracket 40 may extend horizontally such that the screw holes 34 can be defined directily in the flanges 48, and the locating tab 32 can be stamped upward directly from an edge of one of the flanges 48. In such case, the mounting plate 30 is not needed.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A bracket structure comprising:
a first bracket comprising a first plate, a first slideway and a second slideway defined in the first plate;
a second bracket comprising a pair of sliding members for being slidably received in the first and second slideways respectively; and
a locking member slidably mounted to the first plate of the first bracket, the locking member comprising a body for engaging with the sliding members when the second bracket is mounted to the first bracket, and a pair of protrusions each defining an avoiding slot therebelow for allowing the corresponding sliding members to pass therethrough when assembling or disassembling the second bracket to or from the first bracket.

2. The bracket structure as claimed in claim 1, wherein the first slideway comprises two straight portions, and the second slideway comprises two straight portions respectively parallel to the straight portions of the first slideway, the straight portions of the second slideway are interconnected by an arcuate portion.

3. The bracket structure as claimed in claim 1, wherein the first plate further comprises a plurality of aligned pairs of catches arranged thereon, and the first bracket further comprises a first side plate defining a slot aligned with the pairs of catches, and the locking member extends through the slot to locate between every pair of catches.

4. The bracket structure as claimed in claim 3, wherein a first entry communicating with the first slideway, and a second entry communicating with the second slideway are defined in the first side plate.

5. The bracket structure as claimed in claim 1, further comprising a mounting plate mounted to the second bracket, wherein the sliding members are mounted to the mounting plate.

6. The bracket structure as claimed in claim 5, wherein a cutout is defined in an edge of the first plate, an L-shaped locating tab is stamped up from a side of the mounting plate for engaging with the cutout.

7. The bracket structure as claimed in claim 1, wherein the locking member further comprises an operation portion at one end of the body.

8. The bracket structure as claimed in claim 1, wherein the locking member further comprises a locating portion protruding down therefrom, the first plate of the first bracket defines a first locking hole for engaging with the locating portion when assembling or disassembling the second bracket to or from the first bracket, and a second locking hole for engaging with the locating portion when the second bracket is secured to the first bracket.

9. The bracket structure as claimed in claim 1, wherein an opening is defined in the first plate of the first bracket, the locking member still further comprises a resilient finger stamped from the body thereof for engaging in the opening.

10. A computer enclosure, comprising
a chassis having a front panel defining a first opening and a second opening therein;
a first drive bracket attached to the front panel at the first opening, the first drive bracket comprising a first plate, a first slideway and a second slideway defined in the first plate;
a second drive bracket corresponding to the second opening, the second drive bracket comprising a pair of sliding members for being slidably received in the first and second slideways respectively; and
a locking member slidably mounted to the first plate of the first drive bracket, the locking member comprising a body for engaging with the sliding members when the drive second bracket is mounted to the first drive bracket, and a pair of protrusions each defining an avoiding slot therebelow for allowing the corresponding sliding members to pass therethrough when assembling or disassembling the second drive bracket to or from the first drive bracket.

11. The computer enclosure as claimed in claim 10, wherein the first slideway comprises two straight portions, and the second slideway comprises two straight portions respectively parallel to the straight portions of the first slideway, the straight portions of the second slideway are interconnected by an arcuate portion.

12. The bracket structure as claimed in claim 10, wherein the first drive plate further comprises a plurality of aligned pairs of catches arranged thereon, and the first drive bracket further comprises a first side plate defining a slot aligned with the pairs of catches, and the locking member extends through the slot to locate between every pair of catches.

13. The bracket structure as claimed in claim 12, wherein a first entry communicating with the first slideway, and a second entry communicating with the second slideway are defined in the first side plate.

14. The bracket structure as claimed in claim 10, further comprising a mounting plate mounted to the second drive bracket, wherein the sliding members are mounted to the mounting plate.

15. The bracket structure as claimed in claim 14, wherein a cutout is defined in an edge of the first drive plate, an L-shaped locating tab is stamped up from a side of the mounting plate for engaging with the cutout.

16. The bracket structure as claimed in claim 10, wherein the locking member further comprises an operation portion at one end of the body.

17. The bracket structure as claimed in claim 10, wherein the locking member further comprises a locating portion protruding down therefrom, the first plate of the first bracket defines a first locking hole for engaging with the locating portion when assembling or disassembling the second drive bracket to or from the first drive bracket, and a second locking hole for engaging with the locating portion when the second drive bracket is secured to the first drive bracket.
